(19) United States
(12) Patent Application Publication
(10) Pub. No.: US 2009/0174772 A1
(43) Pub. Date: Jul. 9, 2009

(54) SECURITY AND SURVEILLANCE SYSTEM

(76) Inventors: Hollis M. Tapp, Mesquite, TX (US); Joseph C. McAlexander, Murphy, TX (US); James Olivier, Dallas, TX (US); William C. Slemmer, Frisco, TX (US)

Correspondence Address: DOCKET CLERK, P.O. DRAWER 800889, DALLAS, TX, 75380, US

(21) Appl. No.: 12/235,249

(22) Filed: Sep. 22, 2008

Related U.S. Application Data
(60) Provisional application No. 60/994,611, filed on Sep. 20, 2007.

(51) Int. Cl. H04N 7/18

(52) U.S. Cl. 348/143; 348/E07.085

(57) ABSTRACT

A surveillance and security system includes a plurality of detectors and cameras each associated with a zone of interest. Upon detection or sensing of an event within the zone, an event detection signal is generated and transmitted to a security system controller. The controller generates and transmits a notification message over a data network to a remote communications device notifying a user that an event has been detected by the surveillance and security system, and establishes a communication session. This enables a user of the remote communication device to remotely control the surveillance and security system, and activate or perform certain actions within the system.

### CROSS-REFERENCE TO RELATED APPLICATION

This application claims priority under 35 USC 119(e) to U.S. provisional Application Ser. No. 60/994,611, filed on Sep. 20, 2007, and which is incorporated herein by reference.

### TECHNICAL FIELD

The present invention relates generally to security and surveillance systems and, more particularly, to systems, methods and apparatus for providing event notification and enabling control of the security and surveillance system by a remote communications device via a data network.

### BACKGROUND

Prior art security and surveillance systems are network or internet accessible to allow a user to view video signals from one or more security cameras within the system. However, these systems require the user to actively initiate communications with the system log (via a network such as the internet) in order to passively view the video signals.

Accordingly, there are needed systems, methods and apparatus for detecting an event at a security and surveillance system, notifying a remote communication device, and enabling control of the security system through the remote communication device.

### SUMMARY

In accordance with one embodiment, there is provided a method of remotely controlling a surveillance and security system. The method includes detecting an event within a zone in the surveillance security system and generating an event signal in response to the detected event. An event notification message is generated and transmitting to a remote communication device via a data network coupled to the surveillance and security system and the user is notified of the detected event at the remote communication device. User input to the remote communication device enables control of the surveillance and security system, including generating and transmitting a control message to the surveillance and security system via the date network. Receipt of the control message at the surveillance and security system initiates an action to be performed by the surveillance and security system.

In another embodiment, there is provided a surveillance and security system that includes at least one sensor associated with a zone of surveillance for detecting an event occurring within the zone and generating an event detection signal. The system includes a controller that receives the event detection signal and transmits a notification message in response thereto to a remote communications device via a data network coupled to the controller, receives a control message from the remote communication device, and controls at least a portion of the surveillance and system in response to the received control message.

Other technical features may be readily apparent to one skilled in the art from the following figures, descriptions, and claims.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 is an overall block diagram of a security and surveillance system for detecting an event and providing notification and enabling control via a data network to a remote communication device;

FIG. 2 is a more detailed block diagram of the remote communication device shown in FIG. 1;

FIG. 3 is a more detailed block diagram of the control processor shown in FIG. 1; and

FIG. 4 illustrates a method for remote notification of a detected event and user interaction.

### DETAILED DESCRIPTION

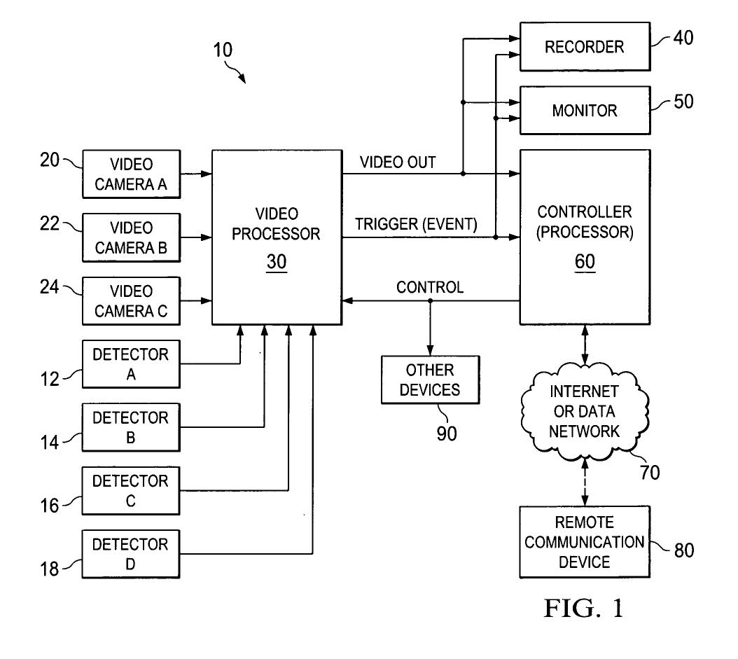

FIG. 1 is a block diagram of a security and surveillance system 10. The security and surveillance system 10 includes a detector or sensor 12 monitoring a zone of surveillance A. Other detectors or sensors 14, 16, and 18 may be used to monitor zones of surveillance B, C, and D, respectively. Any type of detector which detects an undesirable presence (or even a desirable presence) may be used, such as for example, a motion, infrared, microwave, or sound detector. Though security and surveillance system 10 is shown having four zones (A, B, C and D) of surveillance, security and surveillance system 10 may monitor any number of zones of surveillance and each zone of surveillance may have any number of detectors associated therewith. Security and surveillance system 10 also includes video cameras 20, 22 and 24, for each zone of surveillance A, B and C, respectively. As will be appreciated, the detector 18 does not have an associated video camera. Further, the detectors 12, 14 and 16 may be separate from or integrated with the video cameras 20, 22 and 24. Video cameras 20, 22 and 24 may provide still and/or motion video. Each zone of surveillance A, B and C may also have light assemblies (not shown) associated therewith for illumination purposes.

Each video camera 20, 22 and 24 outputs a video signal to a video processor 30. These video signals may be transmitted via wireless or wireline communication links and in accordance with one or more known communication protocols. In one embodiment, video signals are transmitted in accordance with a wireless communication protocol, such as BlueTooth or WiFi. Each detector 12, 14, 16 and 18 outputs a detection or activation signal to the video processor 30 when an event is sensed or detected within the respective zone by the respective detector. Though only one is shown for each detector, multiple detection signal lines may be utilized, one for each type of event detected by the detector if the detector is capable of detecting different types of events. Similarly, the activation signals may be transmitted via wireless or wireline.

When the video processor 30 receives an activation signal from one of the detectors 12, 14, 16, and 18 (indicating that one of the detectors has determined the existence of a presence in a corresponding zone of surveillance), the video processor 30 selects the video signal associated with that detector for output. This video signal is output to a video recorder 40, a video monitor 50 and a security system controller 60. A trigger generator (not shown) generates a trigger or event signal in response to receipt of an activation signal from one of the detectors. Similarly, the event signal is output to the video recorder 40, the video monitor 50 and the security system controller 60. It will be understood that the trigger generator may be a separate device or integrated within the video processor 30 .

In another embodiment not shown, the activation signals from the detectors 12, 14, 16 and 18 may also be input to the security system and control processor 60. This allows the controller 60 to differentiate and identify which detector is activated and/or the type of event detected. In this embodiment, the controller 60 may also output the event signal for input to the video recorder 40 and the video monitor 50.

The video monitor 50 receives the video output signal from the video cameras 20, 22 and/or 24 for display. The video monitor 40 also receives the event signal, which may be used to control the video monitor (e.g., selecting the appropriate video input channel) to display video from the appropriate video camera. As will be appreciated, though not shown, the event signal may also control one or more of the light assemblies.

Similarly, the video recorder 40 receives the video output signal by the video cameras 20, 22 and/or 24 for recording. The video recorder 40 also receives the event signal, which is used to activate the video recorder 40 for recording. It will be understood that the video recorder 40 may be a separate device or integrated within the video processor 30.

In operation, detectors 12, 14, 16, and 18 determine the existence of an undesirable (or desirable) presence in zones of surveillance A, B, C, and D, respectively. A detector determining the existence of a presence, such as an intruder, generates an activation signal received by the video processor 30. The video processor 30 switches the appropriate video input channel to the video output channel. In addition, assuming the video cameras are not always activated, the video processor may activate one of the video cameras 20, 22 and 24 corresponding to the activation signal (or others) and output the appropriate video signal(s).

Upon detection of an event and video channel switching, the security system controller 60 has information identifying the detector activated (and/or type of detected event) and the video output from the video processor 30.

Though FIG. 1 illustrates the video processor 30, the video recorder 40, the video monitor 50 and the security system controller 60 as separate components or devices, two or more of these devices may be integrated into a single device. For example, the video processor 30, the video recorder 40 and the security system controller 60 may be integrated into one device. The system 10 shown in FIG. 1 is for illustration purposes only. Other embodiments of the system 10 may be used without departing from the scope of this disclosure.

In response to a detected event (identity of the detector and/or type of detected event), the security system controller 60 generates a notification message and a communication session is established between the controller 60 and the remote communication device 80. The notification message is transmitted via a data network 70 to the remote communication device 80. In response to the notification message, the security application program 208 within the device 80 provides an audible, video, or mechanical output or notification intended for the user of the device 80. This notification message (or additional messages transmitted from the controller 60) includes data or instructions enabling the remote communication device 80 to communicate with and provide control of the controller 60, thus enabling control of the security and surveillance system 10.

In one embodiment, the controller 60 establishes an active communication session between the controller 60 and remote communication device 80. This may be accomplished through various handshaking between the devices prior to transmission of the notification message, or may be initiated by the notification message itself. Such handshaking and communication setup may be similar to conventional remote desktop control communications methods. However, in accordance with this disclosure, a remote connection is established in response to a detected event. In one embodiment, the remote connection is established automatically in response to a detected event.

Once communications are established, the user inputs data, a response message is generated and transmitted back to the security system controller 60, and the controller 60 initiates or performs some action in accordance with the response message. Such actions may include activating lights, generating an audible alarm, or initiating some other action at the surveillance site or by a device coupled to the controller 60. This may include providing control to select certain video signal(s) for delivery to the remote device 80 or controlling movement (pan, scan) of video cameras at the site, etc. In addition, the controller 60 may stream or otherwise transmit video from one or more of the video cameras (single video or multiple composite) to the remote communication device 80.

The network 70 may include one or more local area networks (“LAN”), metropolitan area networks (“MAN”), wide area networks (“WAN”), all or portions of a global network such as the Internet, or any other communication system or systems at one or more locations, or combination of these, including wireless and wireline. Further, the network 70 may include various servers, routers, bridges, and other access and backbone devices. In one embodiment, the network 70 is a packet network that utilizes any suitable protocol or protocols, and in a specific embodiment, the network 70 (and most components connected thereto) operates in accordance with the Internet Protocol (“IP”) and/or the network 70 is the Internet.

In the embodiment shown, the communications link between the security and surveillance system 10 and the remote communication device 80 includes a wireline link through the internet to one or more intermediate devices (not shown) and a wireless link from an intermediate device (not shown) to the remote communication device 80. In another embodiment (not shown), the communications link may be wireline between the system 10 and communication device 80 wherein the communication device is configured as a remote terminal or server operated by a security monitoring service.

It will be understood that more than one remote communication device 80 may be included within the overall system, and the remote communication devices 80 represent devices that may be communicatively coupled to a data network, including but not limited to phones, computers, modems, PDAs, and other network devices and the like. In this embodiment, the system 10 may be controlled remotely (and video signals received therefrom) by a third party authorized to act on behalf of the owner/user. In another embodiment, the remote communication device may be operated by law enforcement officials. This would enable the local police to review and monitor video from the video cameras if an intrusion or other event occurs and is detected, and perhaps interact at the surveillance site through remote control of the system 10.

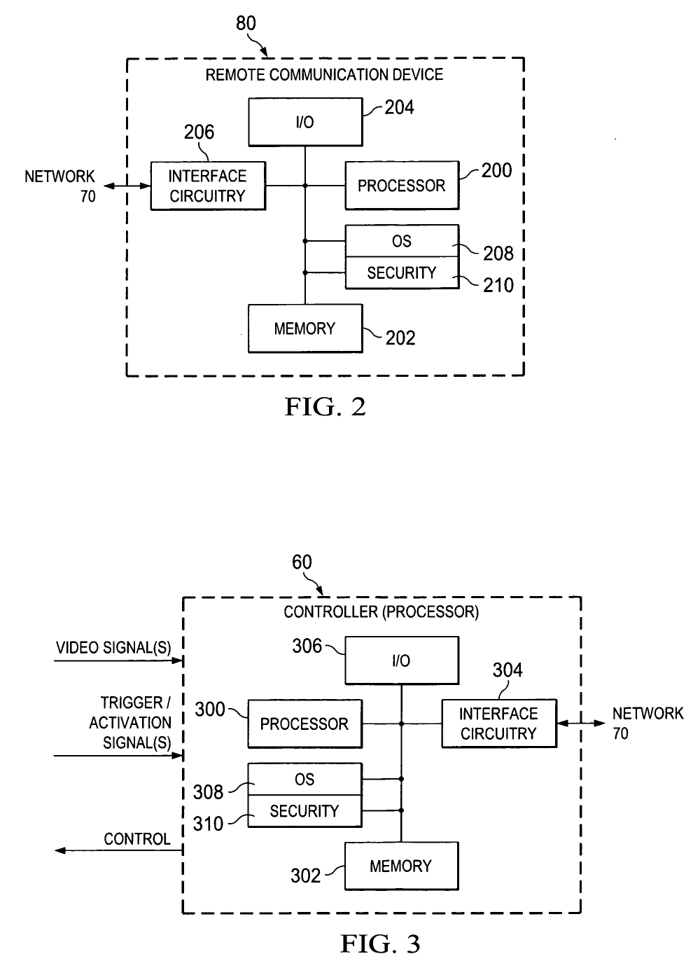

Now referring to FIG. 2, there is shown a general block diagram illustrating one embodiment of the communication device 80. The device 80 includes a processor 200, memory 202, input/output device(s) 204, interface circuitry 206, an operating system 208 and a security application program 210. The input/output devices 204 may include one or more of the following: a video display, audio speaker, microphone, mouse/trackball, keyboard, and any other devices operable for providing input/output functions for the device 80. The remote communication device 80 may be constructed or configured from any suitable hardware, including software and/or firmware, for transmitting or receiving information over the data network 70, and for providing the functionality described herein. Other application software (not shown) may be included.

Now referring to FIG. 3, there is shown a block diagram of the security system controller 60. The security system controller 60 may be constructed or configured from any suitable hardware (processor, memory, input/output, interface circuitry, etc.), including software and/or firmware, for transmitting or receiving information over the network 70, and for providing the functionality described herein.

As shown, the security system controller 60 generally includes a processor 300, internal and/or external memory 302, and network interface circuitry 304 operable for communicating via the network 70, input/output circuitry or devices 306, an operating system 308 and a security application program 310, and related functionality. The input/output devices 304 may include one or more of the following: a video display, audio speaker, microphone, mouse/trackball, keyboard, and any other devices operable for providing input/output functions for the security system controller 60.

Referring back to FIG. 1, the system 10 may include other devices 90 under control of the security system controller 90. The controller 90 enables the remote communication device 80 to control or otherwise activate the other devices 90 and the video processor 30 (via the control line). The types and functions of the other devices 90 can vary, as desired. The video processor 30 may also be controlled to select an output from one of the video cameras for input to the controller 60.

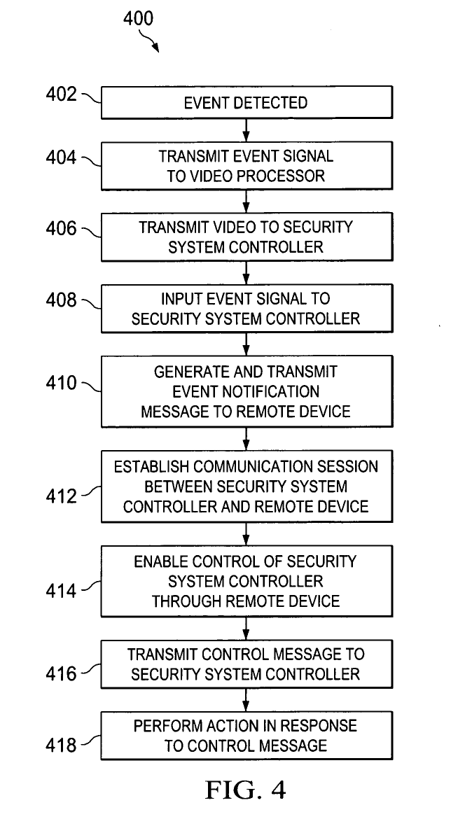

Now referring to FIG. 4, there is shown a method 400 for remote notification of a detected event and user interaction and control of one or more devices within the security system 10.

An event is detected by one of the detectors 12, 14, 16, 18 (step 402). An event or activation signal is generated by the affected detector and transmitted to the video processor 30 (step 404). In response, the video processor switches the video input signal from the affected detector to its video output terminal and the respective video signal is transmitted for input to the security system controller 60 (step 406). An event (trigger) signal corresponding generally to the event or activation signal from the affected detector is input to the controller 60 (step 408).

In response to the event (trigger) signal, the security system controller 60 generates and transmits an event notification message to the remote communication device 80 over the data network 70 (step 410). A communication session is established between the controller 60 and the remote communication device (step 412). This communication session may be initiated (1) by the controller 60 in response to a detected event (either before, after or during transmission of the notification message), (2) by the remote communication device 80 in response to receipt of the notification message, or (3) in some other fashion or method.

It will be understood that the network or other address of the remote communication device 80 is preprogrammed (or programmable) and stored in the memory 202.

The notification message, or other data messages sent during the communication session, includes data or information related to the detected event. Messages may also include other information, including user prompts, menu displays, and other user interface data that enables a user of the remote communication device 80 to input data and communicate with the security system controller 60 upon an event detection. Such user input is designed to control various aspects, functions and devices of the system 10. In one embodiment, the message(s) transmitted to the device 80 may result in the execution of the security application program 310 therein. As will be appreciated, the prompts and user interface functionality may be provide by the security application program 310 and/or may result from the download of this information from the controller 60, thereby enabling the user to control the security and surveillance system 10 (step 414).

After communication session establishment, the remote device 80 is enabled to generate and transmit control messages to the security system controller 60 (step 416). In response, the security system controller 60 takes some action (step 418). Such action(s) may include initiating, controlling, disabling, or otherwise activating a device within the system 10, or causing the system to generate and transmit a message to another device external to the security and surveillance system 10 (such as to a local law enforcement agency or monitoring service).

In one embodiment, the remote device 80 outputs an indication of the type of event detected, and generate prompts and/or a graphical user display providing a mechanism for user input. A custom display may be downloaded which also programs key functions and provides preprogrammed prompts in order to elicit and receive responses/input from the user after the user is notified of the event detection. Various user choices/actions may be displayed, depending on the potential actions to be taken for a specific type of event detected.

It will be understood that the steps identified herein are not required to be performed in or limited to any specific order, and not each and every step may be required or necessary.

The disclosed embodiments describe a “push-pull” technology in which the security and surveillance system pushes event detections or notifications to a remote communication device (including establishment of a communication session), and pulls (solicits or requests) data or instructions therefrom to initiate some action within the security and surveillance system and enable control of the system.

The present disclosure provides a security and surveillance system the ability to initiate a communication session between the security system and a remote communication device enabling or providing event notification and control of the security system through the remote communication device. Various data can be exchanged, including menus and prompts seeking user input for control purposes.

In some embodiments, certain functions and methods performed by the one or more of the devices/elements in system 10 and/or device 80 are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. In this document, the term “couple,” “connect” and their derivatives refer to any direct or indirect communication between two or more elements, whether or not those elements are in physical contact with one another.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for remotely controlling a surveillance and security system, the method comprising:
detecting an event within a zone in the surveillance security system;
generating an event signal in response to the detected event;
generating an event notification message and transmitting the event notification message to a remote communication device via a data network coupled to the surveillance and security system;
notifying a user of the detected event at the remote communication device;
receiving user input for enabling control of the surveillance and security system;
generating and transmitting a control message to the surveillance and security system via the date network; and
receiving the control message at the surveillance and security system and initiating an action to be performed by the surveillance and security system.

2. A surveillance and security system comprising:
at least one sensor associated with a zone of surveillance for detecting an event occurring within the zone and generating an event detection signal; and
a controller operable for:
receiving the event detection signal and transmitting a notification message in response thereto to a remote communications device via a data network coupled to the controller,
receiving a control message from the remote communication device, and
controlling at least a portion of the surveillance and system in response to the received control message.
